(19) United States
(12) Patent Application Publication
(10) Pub. No.: US 2009/0199168 A1
(43) Pub. Date: Aug. 6, 2009

(54) PROGRAM CONVERSION METHOD USING HINT INFORMATION THAT INDICATES ASSOCIATION BETWEEN VARIABLES

(75) Inventors: Tomoo HAMADA, Osaka (JP); Dai HATTORI, Shiga (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/366,237

(22) Filed: Feb. 5, 2009

(30) Foreign Application Priority Data
Feb. 6, 2008 (JP) 2008-026556

(51) Int. Cl. G06F 9/45

(52) U.S. Cl. 717/151

(57) ABSTRACT

A program conversion method that can increase variations of applicable optimizations and effects of the optimization, by being provided with characteristics of a variable or an association between two or more variables as hint information for optimization by a programmer or profiler. The program conversion method converts a source program in a computer and includes: obtaining a constraint equation including at least one of a variable in the source program, a constant, an operator, a pseudo variable, and a built-in function and producing a truth-value; and converting the source program by optimizing the constraint.

### BACKGROUND OF THE INVENTION

(1) Field of the Invention

The present invention relates to a program conversion method that achieves higher execution speed and size reduction of a program.

(2) Description of the Related Art

In language processors which generate, from a source program, a program which can be executed by a target machine, various optimizations are carried out for higher execution speed or size reduction of a program to be generated.

One of the optimizations is a technique that focuses on a value taken by a variable in a program and studies a possible value that can be taken by the variable and frequency of appearance of the value to speed up a process in the case where the variable takes a value with high frequency of appearance (see, for example, Patent Reference: Japanese Unexamined Patent Application Publication No. 2002-222088).

In conventional techniques, however, what a user provides as hint information or what is automatically generated from an analysis result of a profiler is a value that can be taken by an individual valuable in a program and its frequency of appearance. An optimization using such information is, therefore, limited to constant propagation within a function or between functions and to constant folding as an adjunct to the constant propagation.

### SUMMARY OF THE INVENTION

An object of the present invention is to provide a program conversion method that can increase variations of applicable optimizations and effects of the optimization, by being provided with characteristics of a variable or an association between two or more variables as hint information for optimization by a programmer or profiler.

A program conversion method according to an aspect of the present invention is a program conversion method for converting a source program using a computer, the method comprising: obtaining a constraint equation including at least one of: a variable in the source program; a constant; an operator; a pseudo variable; and a built-in function, the constraint equation resulting in a truth-value; and converting the source program by optimizing the source program using the obtained constraint equation.

The source program is optimized with use of the constraint equation as described above. The above structure allows providing characteristics of the variable or an association between two or more variables, thereby increasing variations of applicable optimizations and effects of the optimization compared to conventional method.

Preferably, in the obtaining, a constraint equation that is associated with a function definition is obtained, the constraint equation including a formal parameter, the constant, and the operator, and the converting includes: generating a clone of the function indicated by the associated function definition; optimizing a process within the cloned function by assuming that the constraint equation results in true; and replacing function call statements which call when the constraint equation given by replacing formal parameters by actual parameters results in true.

The process within the function that has been cloned is optimized by assuming that the function definition part constraint results in true, thereby eliminating the need for an operation process of a function definition part constraint. This makes it possible to reduce processing load of the function that is called by the function call statement.

More preferably, in said obtaining, the constraint equation including the pseudo caller part parameters, the constant, and the operator, is obtained and the constraint equation is associated with a function call statement, and the converting includes: generating a clone of the function that is called by the function call statement when the constraint expression which is given by replacing pseudo caller part parameters by the related actual parameter at the call statement results in a true value; optimizing a process within the cloned function by assuming that the constraint equation results invariably in true; and replacing the function that is called by the function call statement with the cloned function.

The process within the function that has been cloned is optimized by assuming that the equation in which the pseudo caller part parameter included in the caller part constraint equation has been replaced with the formal parameter of the function that is called by the function call statement results in true. This allows elimination of the need for an operation process of the equation. This makes it possible to reduce processing load of the function that is called by the function call statement.

More preferably, a pseudo prototype part parameter that is a variable for specifying a formal parameter of function definition at the function declaration is used as the pseudo variable of constraint equation.

Further, in the obtaining, a constraint equation that is a constraint equation associated with a function declaration is obtained, the constraint equation including the pseudo prototype part parameter, the constant, and the operator, and the converting includes: optimizing, in the case where the function definition corresponding to the function declaration exists in the source program, a clone of the function by assuming a constraint equation which is given by replacing pseudo prototype part parameters by formal parameters in the function is true; and replacing the function call statement with a call statement for the function to be cloned, in the case where the constraint equation which is given by replacing pseudo prototype part parameters by actual parameters in the function call results in true.

More preferably, in the obtaining, an inner-function constraint equation is obtained, the inner-function constraint equation including at least a variable in a function, a global variable, a constant, and an operator, and the converting includes: obtaining, as optimization target statements, a statement sequence where all variables in constraint equation are live; generating a conditional branching statement including: statements that are obtained by optimizing the optimization target statements assuming the inner-function constraint equation results in true, as a process in the case where a result of a conditional expression is true; and the original optimization target statements in the case where a result of the conditional expression is false, the conditional expression being the inner-function constraint equation; and replacing the optimization target statements by the generated conditional branch statement that has been generated.

In the case where a result of the constraint equation is true, it is possible to execute the optimized statement. This makes it possible to reduce processing load of the function when the provided constraint equation is satisfied.

More preferably, in the obtaining, an inner-function constraint equation is obtained, the inner-function constraint equation including at least one of a variable in a function, a global variable, the constant, and the operator, and the converting includes: obtaining, from the function, two or more branch conditions, two or more branch destinations and a branch statement that includes an exclusive operation for each of the branch destinations or a branch-statement sequence; and rearranging an order of evaluating a conditional expression of the branch statement or the branch-statement sequence in the case where an equation same as the inner-function constraint equation is included in any one of the two or more branch conditions.

It is possible to reduce necessary processing load for estimating a conditional expression when an expression given in a constraint equation is formed, by rearranging orders for estimating the conditional expression so that estimation for the conditional expression specified by the constraint equation is prioritized.

It should be noted that the present invention can be implemented, in addition to implementation as a program conversion method including characteristic steps described above, as a program conversion apparatus including the characteristic steps of the program conversion method as its components, and as a program which, when loaded into a computer, allows a computer to execute the characteristic steps of the program conversion method. It should be understood that such a program can be distributed via a recording medium such as a compact disc-read only memory (CD-ROM) and a communication network such as the Internet.

According to the present invention, it is possible to increase variations of applicable optimizations and effects of the optimization by converting a source program using the constraint equation described above.

### FURTHER INFORMATION ABOUT TECHNICAL BACKGROUND TO THIS APPLICATION

The disclosure of Japanese Patent Application No. 2008-026556 filed on Feb. 6, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is an external view of a program conversion apparatus.

FIG. 2 is a block diagram that illustrates a functional configuration of the program conversion apparatus.

FIG. 3 is a flowchart that illustrates program conversion processing executed by the program conversion apparatus.

FIG. 4 is a diagram that explains an example of description method of a constraint equation.

FIG. 5 is a flowchart that illustrates an overview of optimization processing of an intermediate representation performed by an intermediate representation conversion unit.

FIG. 6 is a flowchart that illustrates conversion processing of a source program using a function definition part constraint including a formal parameter, a constant, and an operator of a function.

FIG. 7 is a diagram that explains an example of executing program conversion using the function definition part constraint.

FIG. 8 is a flowchart that illustrates conversion processing of a source program 110 using a caller part constraint equation including an actual parameter, a constant, and an operator of a function.

FIG. 9 is a diagram that explains an example of executing program conversion using the caller part constraint equation.

FIG. 10 is a flowchart that illustrates conversion processing of a source program using an inner-function constraint equation including a variable, a constant, and an operator within a function.

FIG. 11 is a diagram that explains an example of executing program conversion using the inner-function constraint equation.

FIG. 12 is a flowchart that illustrates conversion processing of a source program 110 using an inner-function constraint equation including a variable, a constant, and an operator within a function.

FIG. 13 is a diagram that explains an example of executing program conversion using the inner-function constraint equation.

### DESCRIPTION OF THE PREFERRED EMBODIMENT

A program conversion apparatus according to an embodiment of the present invention will be described below with reference to the drawings.

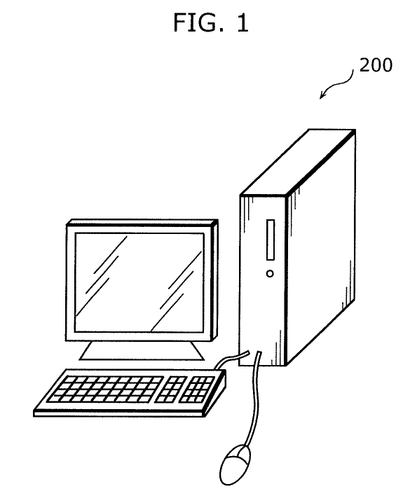

FIG. 1 is an external view of a program conversion apparatus. A program conversion apparatus 200 is a usual computer and implemented by executing a program on a processor of the computer. It is to be noted that various data such as intermediate data during executing a program are stored in a memory of the computer. Further, the program can be stored in a computer-readable recording medium and distributed.

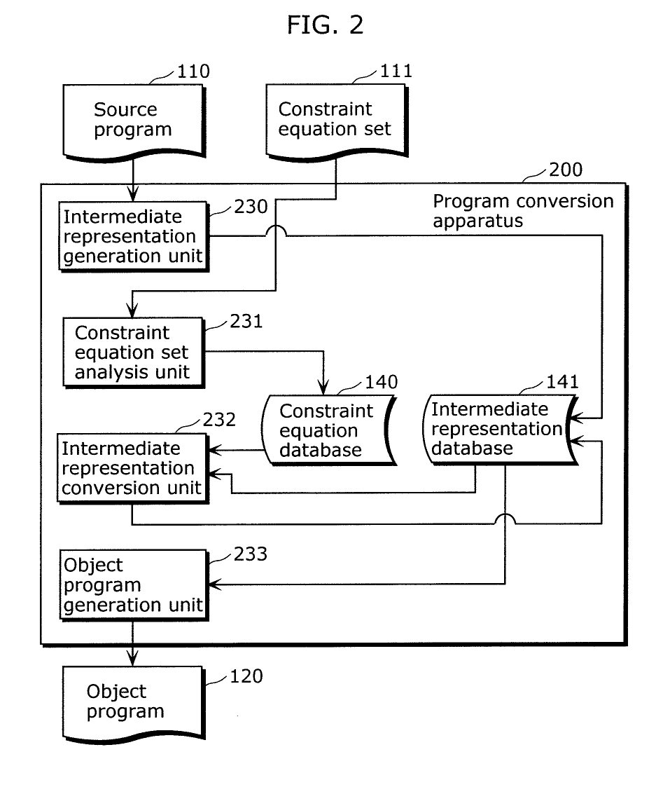

FIG. 2 is a block diagram that illustrates a functional configuration of the program conversion apparatus.

A program conversion apparatus 200 receives, as inputs, a source program 110 described in a high-level language program and a constraint equation set 111, converts the source program 110, and outputs an object program 120 that is a conversion result. Here, the constraint equation set 111 includes a set of equations (hereinafter referred to as “constraint equations”) each of which contains at least one of: a variable; a constant; and an operator, which are included in the source program 110; and a pseudo variable; and a built-in function, which are provided by the program conversion apparatus 200, and results in a truth-value.

The program conversion apparatus 200 includes: an intermediate representation generation unit 230; a constraint equation set analysis unit 231; an intermediate representation conversion unit 232; an object program generation unit 233; a constraint equation database 140; and an intermediate representation database 141.

The intermediate representation generation unit 230 is a processing unit that converts the source program 110 into an intermediate representation that is an internal data representation of the program conversion apparatus 200 and stores the converted source program in the intermediate representation database 141.

The constraint equation set analysis unit 231 is a processing unit that converts a constraint equation included in the constraint equation set 111 into an equation representation that is the internal data representation of the program conversion apparatus 200 and stores the converted constraint equation in the constraint equation database 140.

The intermediate representation conversion unit 232 is a processing unit that converts an internal representation of the source program 110 included in the intermediate representation database 141 based on information in the constraint equation database 140 and stores the converted internal representation in the intermediate representation database 141.

The object program generation unit 233 is a processing unit that generates an object program 120 based on a detail of the intermediate representation database 141 in a format suitable to a target machine and outputs the generated object program 120.

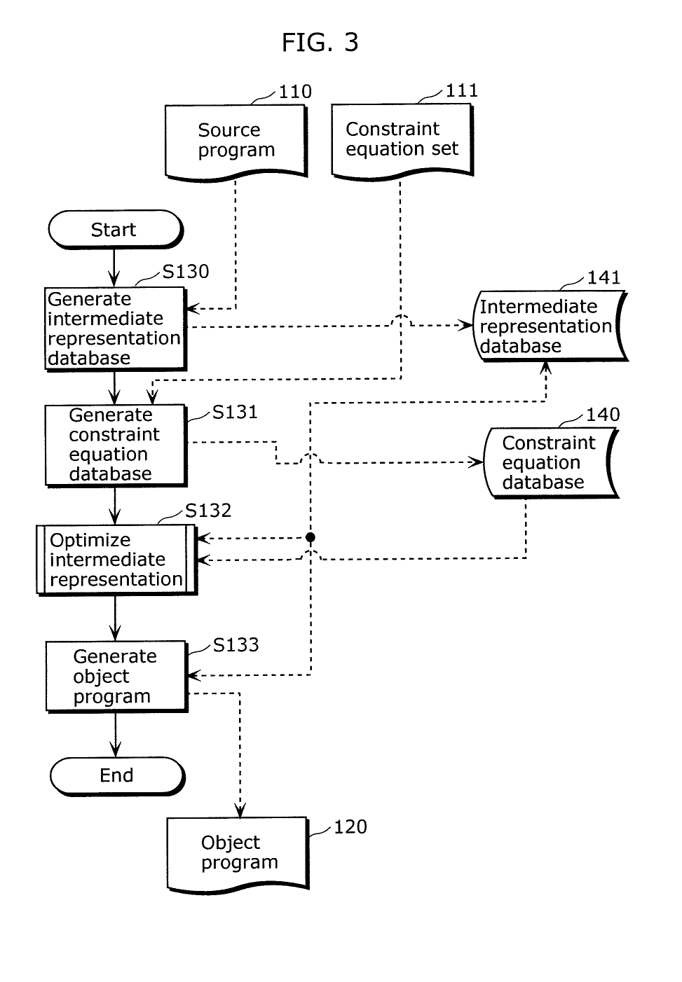

FIG. 3 is a flowchart that illustrates program conversion processing executed by the program conversion apparatus 200.

The intermediate representation generation unit 230 converts the source program 110 into an intermediate representation and stores the converted source program in the intermediate representation database 141 (Step S130). A three address code and an abstract syntax tree are general forms used for an intermediate representation and can be used for the present invention as well.

The constraint equation set analysis unit 231 converts a constraint equation set 111 into an equation representation that is the internal data representation of the program conversion apparatus 200 and stores the converted constraint equation set 111 in the constraint equation database 140 (Step S131). A general form for the equation representation includes an expression tree structure.

The intermediate representation conversion unit 232 converts a detail of the intermediate representation database 141 based on information in the constraint equation database 140 and stores the converted details in the intermediate representation database 141 (Step S132). An object of the conversion is speeding up an operation or reduction in the program size.

The object program generation unit 233 generates an object program 120 based on a detail of the intermediate representation database 141 in a format suitable to the target machine and outputs the generated object program 120 (Step S133).

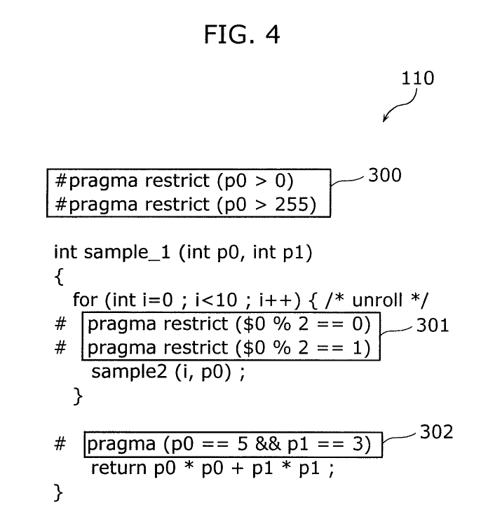

FIG. 4 is a diagram that explains an example of description method of a constraint equation.

In the source program 110 illustrated in FIG. 4, a designator 300 is a function definition part constraint that includes a formal parameter of a function sample_1. The first row of the designator 300 specifies, regarding the formal parameter p0, performing optimization for an operation of the function sample_1 assuming formation of a conditional expression p0>0. The second row of the designator 300 specifies performing optimization for the operation in the case where formation of p0>255 is assumed.

A designator 301 is an caller part constraint equation using a pseudo variable that corresponds to a formal parameter of a function to be called (here, function sample 2). In the example, “$0,”, “$1”, . . . are assumed to be the 0th formal parameter, the first formal parameter, . . . of the function to be called, respectively. The first row of the designator 301 specifies performing optimization of an operation in the function sample_2 in the case where the 0th argument of the function sample_2 leaves a remainder of 0 when divided by two. The second row of the designator 300 specifies performing optimization of an operation in the function sample_2 in the case where the 0th argument of the function sample_2 leaves a remainder of 1 when divided by two.

The designator 302 is an inner-function constraint equation that includes a variable within a function. The designator 302 specifies optimization for an operation of the next row in the case where p0==5 and p1==3 are formed.

Although the constraint equation is given by the designator in the above example, the constraint equation can be defined by, for example, a file different from the input file, as long as a name of a variable and information regarding a live range of each of the variables are included.

Next, optimization processing of the intermediate representation performed by the intermediate representation conversion unit 232 (Step S132) will be described by refereeing to a specific conversion example.

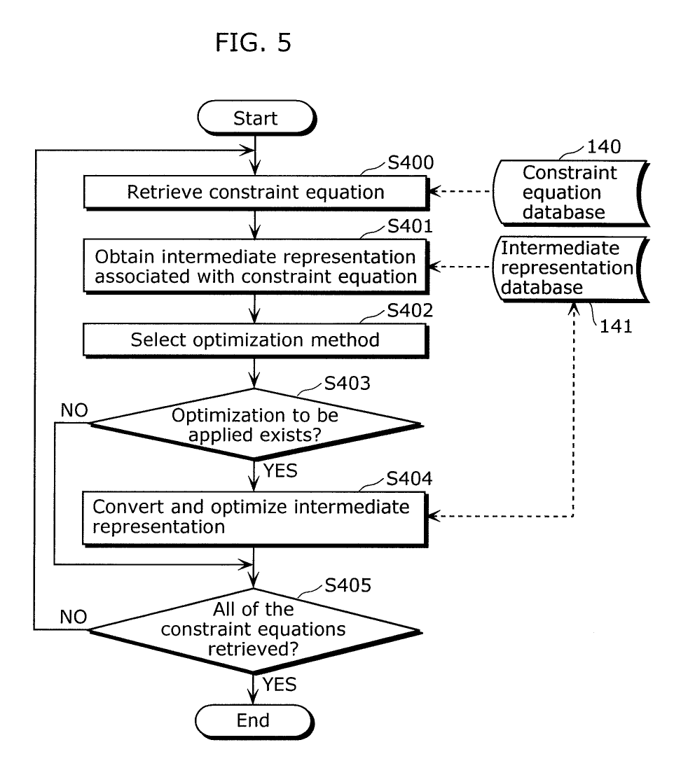

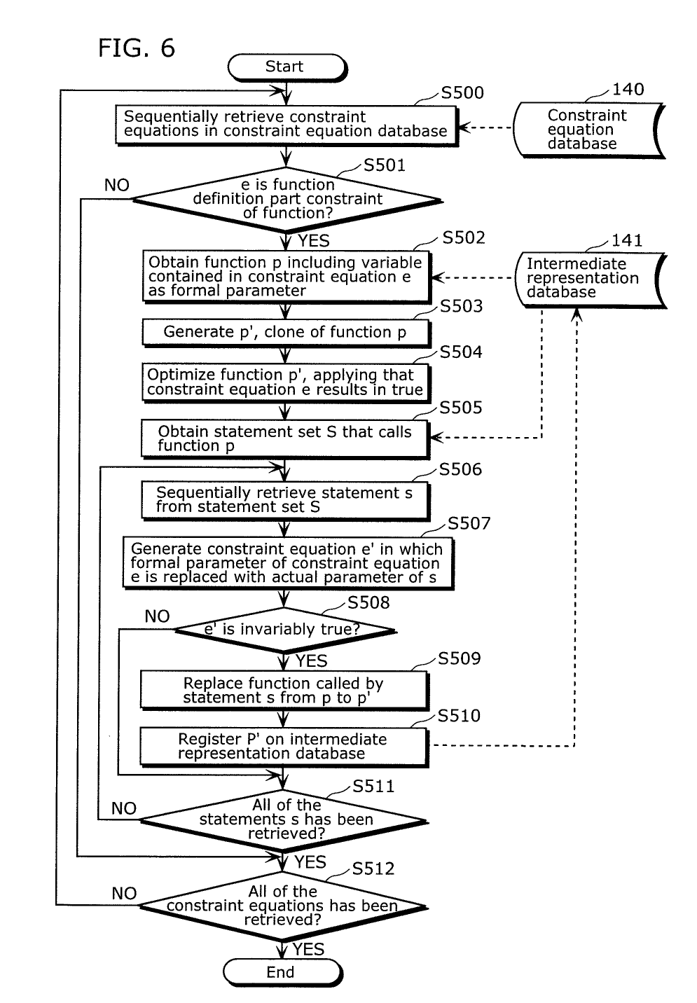

FIG. 5 is a flowchart that illustrates an overview of optimization processing (Step S132) of an intermediate representation performed by an intermediate representation conversion unit 232. It is to be noted that details for each process hereafter will be described with reference to FIG. 6 and subsequent diagrams.

The intermediate representation conversion unit 232 sequentially retrieves all of the constraint equations in the constraint equation database 140, and the retrieved constraint equation is assumed to be e (Step S400).

The intermediate representation conversion unit 232 retrieves, from the intermediate representation database 141, a statement, a function, or a declaration, each of which is associated with the constraint equation e, and the retrieved statement, function, or declaration is assumed to be an intermediate representation s (Step S401).

The intermediate representation conversion unit 232 analyzes the constraint equation e and the intermediate representation s associated with the constraint equation e, and selects an effective optimization method that is applicable to the internal representation of the source program 110 (Step S 402). The optimization method obtained here is assumed to be m.

In the case where an effective and applicable optimization method has been obtained (Yes, in Step S403), the intermediate representation conversion unit 232 converts and optimizes the intermediate representation s based on the constraint equation e and the optimization method m. Further, the intermediate representation conversion unit 232 stores, into the intermediate representation database 141, the intermediate representation s that has been converted and optimized (Step S404).

In the case where an effective and applicable optimization method has not been obtained (No, in Step S403), or subsequent to the intermediate representation optimization (Step S404), the intermediate representation conversion unit 232 judges whether or not all of the constraint equations in the constraint equation database 140 has been retrieved (Step S405). In the case where all of the constraint equations has been retrieved (Yes, in Step S405), the intermediate representation conversion unit 232 ends the processing. In the case where not all of the constraint equations has been retrieved (No, in Step S405), the intermediate representation conversion unit 232 repeats the process in Step S400 and subsequent processes.

Next, an optimization of the intermediate representation carried out for each constraint equation type by the intermediate representation conversion unit 232 (Step S132 in FIG. 5) will be described.

FIG. 6 is a flowchart that illustrates conversion processing of the source program 110 using a function definition part constraint including a formal parameter, a constant, and an operator of a function.

The intermediate representation conversion unit 232 sequentially retrieves all of the constraint equations in the constraint equation database 140, and the retrieved constraint equation is assumed to be e (Step S500).

In the case where the constraint equation e is a function definition part constraint (Yes, in Step S501), the intermediate representation conversion unit 232 obtains, from the intermediate representation database 141, a function p including a formal parameter that is a variable included in the constraint equation e (Step S502).

The intermediate representation conversion unit 232 generates a function p′ that is a clone of the function p (Step S503).

The intermediate representation conversion unit 232 optimizes the function p′, assuming that the constraint equation e results in true (Step S504).

The intermediate representation conversion unit 232 obtains, from the intermediate representation database 141, a set of function call statements S that calls the function p (Step S505).

The intermediate representation conversion unit 232 sequentially retrieves an element of the set of function call statements S, and the retrieved function call statement is assumed to be s (Step S 506).

The intermediate representation conversion unit 232 generates a constraint equation e′ in which a variable included in the constraint equation e, that is, a formal parameter of the function p has been replaced with an actual parameter corresponding to the function call statement s (Step S507).

In the case where it is ensured that the constraint equation e′ is invariably true (Yes, in Step S508), the intermediate representation conversion unit 232 replaces the function that is called by the function call statement s so that the function p is changed to the function p′ (Step S509) and registers the function P′ and updated function call statement s on the intermediate representation database 141 (Step S510).

In the case where it is not ensured that the constraint equation e′ is invariably true (No, in Step S508), or subsequent to the process in Step S510, the intermediate representation conversion unit 232 judges whether or not all of the function call statements s included in the set S has been retrieved (Step S511). In the case where the function call statement s that has not been retrieved exists (No, in Step S511), the intermediate representation conversion unit 232 repeats the process in Step S506 and subsequent processes.

In the case where all of the function call statements s has been retrieved (Yes, in Step S511), or where the retrieved constraint equation e is not a function definition part constraint (No, in Step S501), the intermediate representation conversion unit 232 judges whether or not all of the constraint equations in the constraint equation database 140 has been retrieved (Step S512). In the case where all of the constraint equations has been retrieved (Yes, in Step S512), the intermediate representation conversion unit 232 ends the processing. In the case where not all of the constraint equations has been retrieved (No, in Step S512), the intermediate representation conversion unit 232 repeats the processes in Step S500 and subsequent processes.

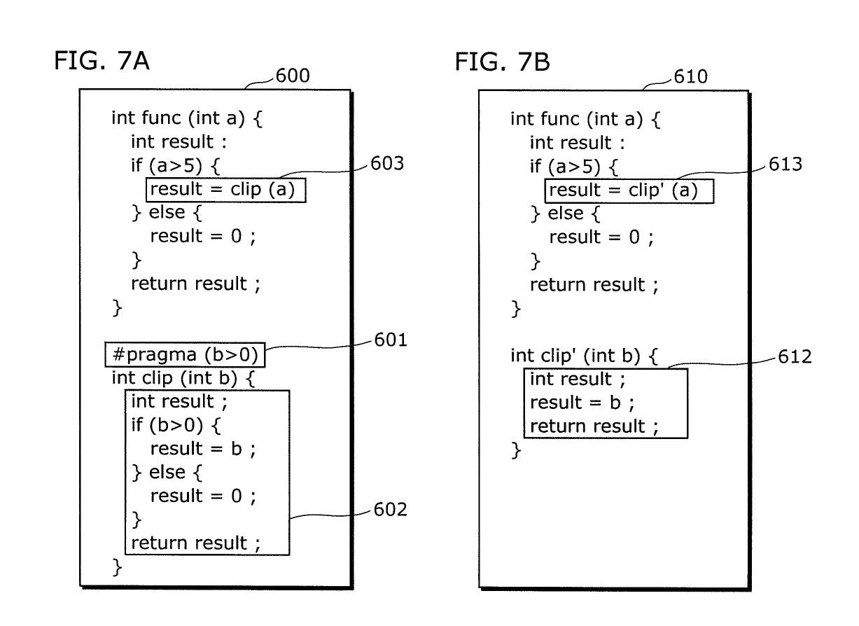

Next, an example of executing program conversion using the function definition part constraint will be explained with reference to FIG. 7. FIG. 7A illustrates a program 600 that is an example of the source program 110. FIG. 7B illustrates a program 610 that is a result of converting the program 600.

It is assumed that the intermediate representation conversion unit 232 has retrieved a designator 601 “b>0” as the constraint equation e from the constraint equation database 140 (Step S500).

Since the retrieved constraint equation “b>0” is a function definition part constraint (Yes, in Step S501), the intermediate representation conversion unit 232 obtains, from the intermediate representation database 141, a function clip to which the constraint equation “b>0” is added (Step S502).

The intermediate representation conversion unit 232 generates a function clip′ that is a clone of the function clip (Step S503).

The intermediate representation conversion unit 232 optimizes the function clip′, assuming that the constraint equation “b>0” results in true (Step S504). In this execution example, a conditional expression of an if statement that evaluates “b>0” is replaced with a constant “true”. This allows reduction of a condition judgment and processing of an else portion, producing a statement 612 that is the processing details of the function clip′.

The intermediate representation conversion unit 232 obtains, from the intermediate representation database 141, a set S of a function call statements 603 that calls the function clip (Step S505).

The intermediate representation conversion unit 232 retrieves the function call statement 603 from the set S (Step S 506).

The intermediate representation conversion unit 232 obtains a constraint equation “a>0” in which the formal parameter b of the constraint equation “b>0” has been replaced with an actual parameter a of the function call statement 603 (Step S507).

As can be seen from the conditional expression “if (a>5)” immediately preceding the function call statement 603, it is ensured that the constraint equation “a>0” results invariably in true when executing the function call statement 603. Since it is ensured that the constraint equation “a>0” results invariably in true (Yes, in Step S508), the intermediate representation conversion unit 232 replaces the function that is called by the function call statement 603 so that the function is changed from the function clip to the function clip′ and generates a function call statement 613 that has been updated (Step S509).

As described above, branching operations contained in the function clip can be reduced by converting the program 600 to the program 610.

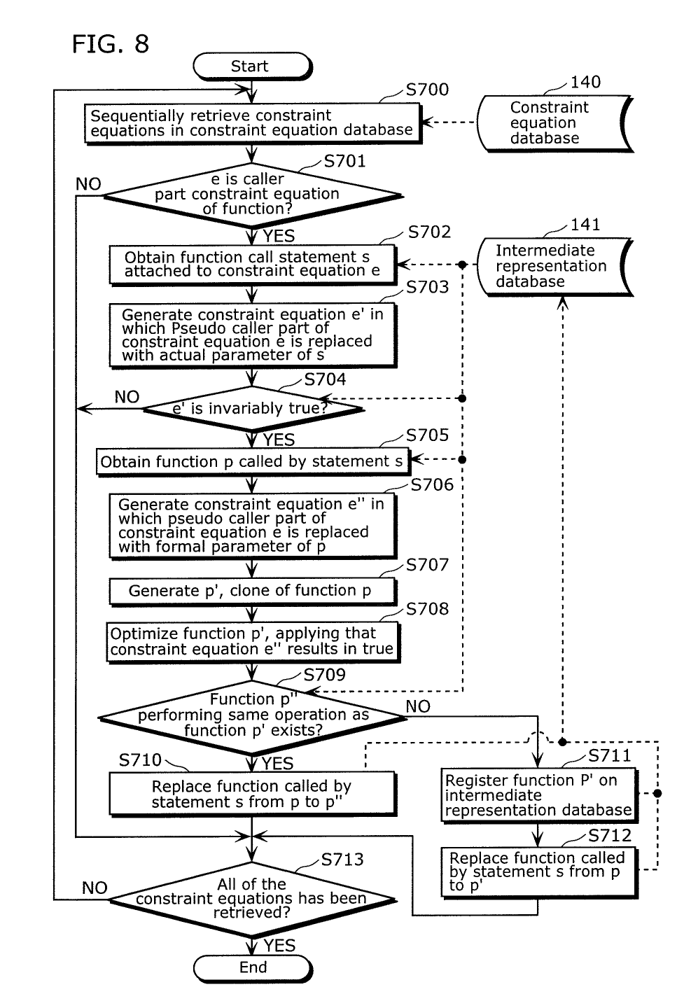

FIG. 8 is a flowchart that illustrates conversion processing of the source program 110 using an caller part constraint equation including an actual parameter, a constant, and an operator of a function.

The intermediate representation conversion unit 232 sequentially retrieves all of the constraint equations in the constraint equation database 140, and the retrieved constraint equation is assumed to be e (Step S700).

In the case where the constraint equation e is an caller part constraint equation (Yes, in Step S701), the intermediate representation conversion unit 232 obtains, from the intermediate representation database 141, a function call statement s to which the constraint equation e is attached (Step S702).

The intermediate representation conversion unit 232 generates a constraint equation e′ in which a pseudo caller part parameter included in the constraint equation e has been replaced with an actual parameter of a function included in the function call statement s (Step S703).

The intermediate representation conversion unit 232 judges whether or not the constraint equation e′ is invariably true (Step S704). In the case where it is ensured that the constraint equation e′ is invariably true (Yes, in Step S704), the intermediate representation conversion unit 232 obtains, from the intermediate representation database 141, a function p that is called by the function call statement s (Step S705).

The intermediate representation conversion unit 232 generates a constraint equation e″ in which the pseudo formal parameter included in the constraint equation e has been replaced with a formal parameter of the function p (Step 5706).

The intermediate representation conversion unit 232 generates a function p′ that is a clone of the function p (Step S707).

The intermediate representation conversion unit 232 optimizes the function p′ using the condition that the constraint equation e″ results in true (Step S708).

The intermediate representation conversion unit 232 judges whether or not a function p″ that performs the same operation as the function p′ is stored in the intermediate representation database 141 (Step S709). In the case where the function p″ is stored in the intermediate representation database 141 (Yes, in Step S709), the intermediate representation unit 232 replaces the function that is called by the function call statement s so that the function is changed from the function p to the function p″, and registers, on the intermediate representation database 141, the function call statement s that has been updated (Step S710).

In the case where the function p″ is not stored in the intermediate representation database 141 (No, in Step S709), the intermediate representation unit 232 registers the function p′ on the intermediate representation database 141 (Step S711). Further, the intermediate representation conversion unit 232 replaces the function that is called by the function call statement s so that the function is changed from the function p to the function p′, and registers, on the intermediate representation database 141, the function call statement s that has been updated (Step S712).

The intermediate representation conversion unit 232 judges whether or not all of the constraint equations in the constraint equation database 140 has been retrieved (Step S713). In the case where all of the constraint equations has been retrieved (Yes, in Step S713), the intermediate representation conversion unit 232 ends the processing. In the case where not all of the constraint equations has been retrieved (No, in Step S713), the intermediate representation conversion unit 232 repeats the processes in Step S700 and subsequent processes.

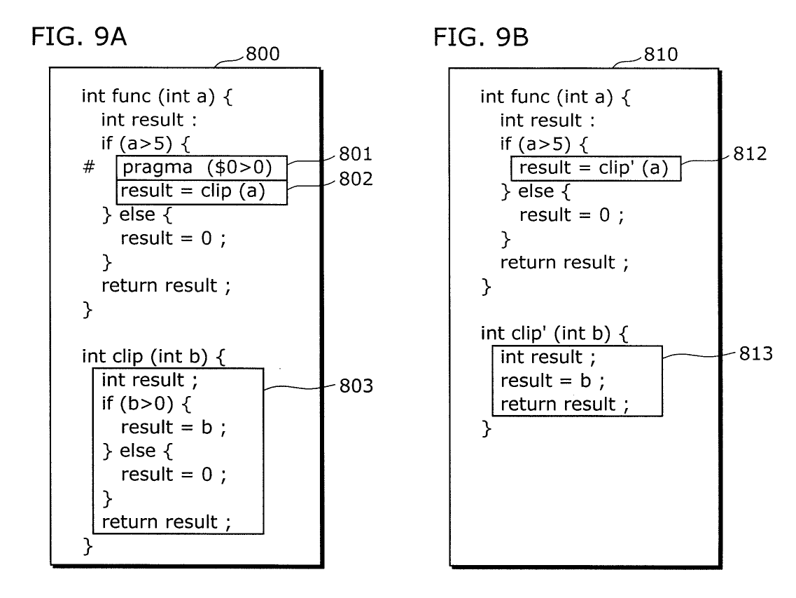

Next, an example of executing program conversion using the caller part constraint equation will be explained with reference to FIG. 9. FIG. 9A illustrates a program 800 that is an example of the source program 110. FIG. 9B illustrates a program 810 that is a result of converting the program 800.

It is assumed that the intermediate representation conversion unit 232 has retrieved a designator 801 “$0>0” as the constraint equation e from the constraint equation database 140 (Step S700).

Since the retrieved constraint equation e is the caller part constraint equation (Yes, in Step S701), the intermediate representation conversion unit 232 obtains a function call statement 802 to which the constraint equation e is attached (Step S702).

The intermediate representation conversion unit 232 obtains “a>0” as an expression e′ in which a pseudo caller part parameter $0 included in the constraint equation “$0>0” has been replaced with the actual parameter of the function call statement 802 (Step S703).

As can be seen from the conditional expression “if (a>5)” immediately preceding the function call statement 802, it is ensured that the expression e′ results in true when executing the function call statement 802 (Yes, in Step S704). For the above reason, the intermediate representation conversion unit 232 retrieves the function clip that is called by the function call statement s (Step S705).

The intermediate representation conversion unit 232 obtains “b>0” as an expression e″ in which a pseudo caller part parameter included in the constraint equation “$0>0” has been replaced with a formal parameter of the function clip (Step S706).

The intermediate representation conversion unit 232 generates a clone function clip′ of the function clip (Step S707).

The intermediate representation conversion unit 232 optimizes the function clip′ using the constraint equation e″, that is, “b>0” (Step S708). In this execution example, a conditional expression of an if statement that evaluates “b>0” is replaced with a constant “true”. This allows reduction of a condition judgment and processing of an else portion, producing a statement 813 that is the processing details of the function clip′.

It is assumed here that the intermediate representation database 141 does not include a function that performs the same operation as the function clip′ (No, in Step S709). For the above reason, the intermediate representation conversion unit 232 registers the function clip′ on the intermediate representation database 141 (Step S711).

The intermediate representation conversion unit 232 replaces the function that is called by the function call statement 802 so that the function is changed from the function clip to the function clip′, and generates the function call statement 812 that has been updated (Step S712).

As described above, branching operations contained in the function clip can be reduced by converting the program 800 to the program 810.

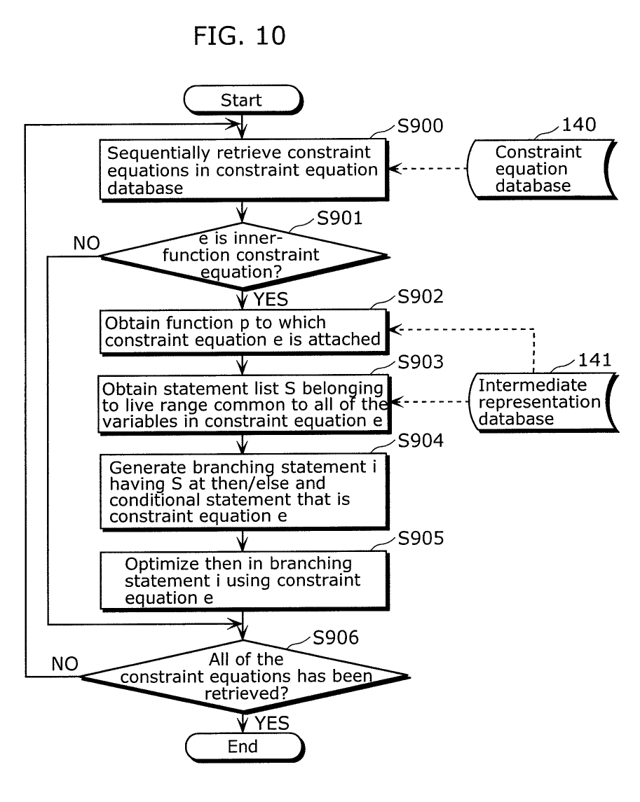

FIG. 10 is a flowchart that illustrates conversion processing of a source program 110 using a inner-function constraint equation including a variable, a constant, and an operator within a function.

The intermediate representation conversion unit 232 sequentially retrieves all of the constraint equations in the constraint equation database 140, and the retrieved constraint equation is assumed to be e (Step S900).

The intermediate representation conversion unit 232 judges whether or not the constraint equation e is a inner-function constraint equation (Step S901). In the case where the constraint equation e is the inner-function constraint equation (Yes, in Step S901), the intermediate representation conversion unit 232 retrieves, from the intermediate representation database 141, a function p to which the constraint equation e is attached (Step S902).

The intermediate representation conversion unit 232 obtains a live range that is common to all of the variables in the constraint equation e of the function p, and obtains a list S including a statement that exists within the range (Step S903).

The intermediate representation conversion unit 232 generates a conditional branching statement i that has a statement of the list S at each branch destination and includes a conditional branching statement that is the constraint equation e, and registers the conditional branching statement i on the intermediate representation database 141 (Step S904).

The intermediate representation conversion unit 232 optimizes the statement that is executed when the conditional expression of the conditional branching statement i results in true by using the condition that the constraint equation e results in true, and stores a result of the optimization in the intermediate representation database 141 (Step S905).

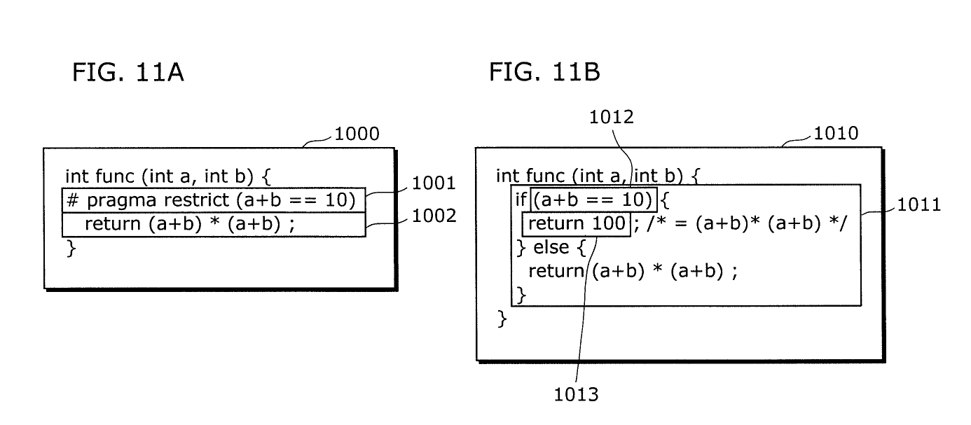

Next, an execution example of a program conversion using the inner-function constraint equation will be described with reference to FIG. 11. FIG. 11A illustrates a program 1000 that is an example of the source program 110. FIG. 11B illustrates a program 1010 that is a result of converting the program 1000.

It is assumed that the intermediate representation conversion unit 232 has retrieved a designator 1001 “a+b==10” as the constraint equation e from the constraint equation database 140 (Step S900).

Since the retrieved constraint equation e is the inner-function constraint equation (Yes, in Step S901), the intermediate representation conversion unit 232 retrieves a function func to which the constraint equation e is attached (Step S902).

The intermediate representation conversion unit 232 obtains a live range that is common to all of the variables in the constraint equation e of the function func, and obtains a list S including a statement that exists within the range (Step S903). In this execution example, the live range common to all of the variables in the constraint equation e is the range from a start to an end of a statement 1002. For that reason, the list S is a list of a statement including only the statement 1002.

The intermediate representation conversion unit 232 generates a conditional branching statement i that has a statement of the list S, that is, the statement 1002, at each branch destination and includes a conditional branching statement that is the constraint equation e (Step S904). In the execution example, a statement 1011 corresponds to the conditional branching statement i.

The intermediate representation conversion unit 232 optimizes the statement that is executed when the conditional expression results in true, assuming that a conditional statement of the conditional branching statement i, that is, “a+b==10” results in true (Step S905). In the execution example, a right-hand side of the statement 1002 “(a+b)*(a+b)” can be converted to “10*10” with use of the constraint equation “a+b==10”, and further converted to “100” since “10*10” is “100”. A result of the replacement is a statement 1013.

As described above, two additions and one multiplication can be replaced with condition judgment and branching by converting the program 1000 to the program 1010.

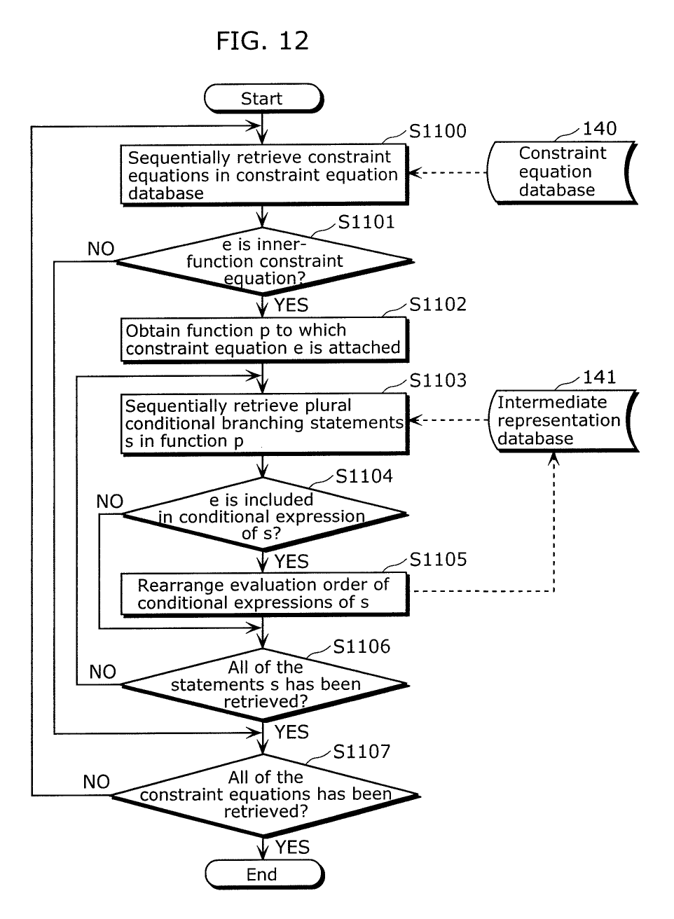

FIG. 12 is a flowchart that illustrates conversion processing of the source program 110 using a inner-function constraint equation including a variable, a constant, and an operator within a function.

The intermediate representation conversion unit 232 sequentially retrieves all of the constraint equations in the constraint equation database 140, and the retrieved constraint equation is assumed to be e (Step S1100).

The intermediate representation conversion unit 232 judges whether or not the constraint equation e is a inner-function constraint equation (Step S1101). In the case where the constraint equation e is the inner-function constraint equation (Yes, in Step S1101), the intermediate representation conversion unit 232 retrieves a function p to which the constraint equation e is attached (Step S1102).

The intermediate representation conversion unit 232 obtains, from the function p, two or more branch conditions, two or more branch destinations and a branch statement that includes an exclusive operation for each of the branch destinations or a branch-statement sequence s (Step S1103).

In the case where the conditional expression of the branch statement or the branch-statement sequence s includes the same equation as the constraint equation e (Yes, in Step S1104), the intermediate representation conversion unit 232 modifies an order to evaluate the conditional expression of the branch statement or the branch-statement sequence s so that the conditional expression e is evaluated first, and updates the intermediate representation database 141 (Step S1105).

In the case where the conditional expression of the branch statement or the branch-statement sequence s does not include the same equation as the constraint equation e (No, in Step S1104) or subsequent to the process of S1105, the intermediate representation conversion unit 232 judges whether or not all of the branch statements or the branch-statement sequences s has been retrieved from the function p (Step S1106). In the case where not all of the branch statements or the branch-statement sequences s has been retrieved (No, in Step S1106), the intermediate representation conversion unit 232 repeats the processes in Step S1103 and subsequent processes.

In the case where all of the branch statements or the branch-statement sequences s has been retrieved (Yes, in Step S1106), the intermediate representation conversion unit 232 judges whether or not all of the constraint equations e in the constraint equation database 140 has been retrieved (Step S1107). In the case where all of the constraint equations e has been retrieved (Yes, in Step S1107), the intermediate representation conversion unit 232 ends the processing. In the case where not all of the conditional expressions e has been retrieved (No, in Step S1107), the intermediate representation conversion unit 232 repeats the processes in Step S1100 and subsequent processes.

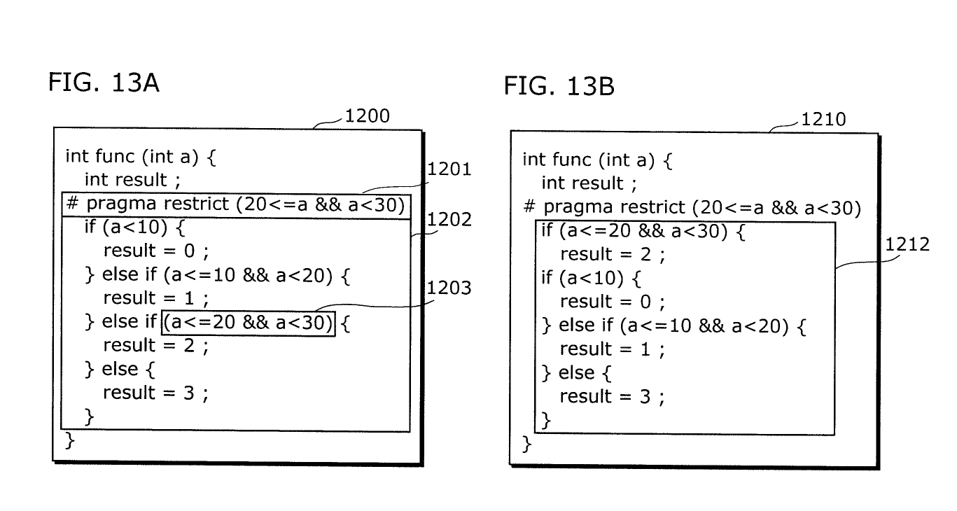

Next, an execution example of program conversion using the inner-function constraint equation will be explained with reference to FIG. 13.

FIG. 13A illustrates a program 1200 that is an example of the source program 110. FIG. 13B illustrates a program 1210 that is a result of converting the program 1200.

It is assumed that the intermediate representation conversion unit 232 has retrieved a designator 1201 “20<=a&&a<30” as the constraint equation e from the constraint equation database 140 (Step S1100).

Since the retrieved constraint equation e is the inner-function constraint equation (Yes, in Step S1101), the intermediate representation conversion unit 232 retrieves a function func to which the constraint equation e is attached (Step S1102).

The intermediate representation conversion unit 232 obtains a sequence of branch statements 1202 that includes two or more branch conditions and two or more branch destinations (hereinafter referred to as “conditional branching statement”) (Step S1103).

The intermediate representation conversion unit 232 determines that the conditional expression 1203 of the conditional branching statement 1202 is the same as the constraint equation e (Yes, in Step S1104).

For that reason, the intermediate representation conversion unit 232 converts the conditional branching statement 1202 so that the conditional expression 1203 is evaluated first. A result of the conversion is the conditional branching statement 1212 (Step S1105).

As described above, evaluation of the conditional expression specified by the constraint equation e can be prioritized by converting the program 1200 to the program 1210, thereby reducing processing load of the program.

As described above, according to the embodiment of the present invention, it is possible to provide a processor with a characteristic of a variable or a relationship between variables as a constraint equation or a constraint equation with frequency of appearance, thereby enabling execution of a number of optimizations.

It is to be noted that the built-in function in the constraint equation described above may be a constant judgment built-in function that returns true when an argument is a constant and returns false when an argument is not a constant.

Further, although a program conversion using a function definition part constraint has been described with reference to FIG. 6 and FIG. 7, the function definition part constraint may be placed not immediately before a function definition, but a function prototype declaration (function declaration). In this case, optimization for the function definition corresponding to the function declaration is carried out according to the same method as shown in FIG. 6 and FIG. 7.

More specifically, a pseudo prototype part parameter that is a variable for specifying the argument in the function declaration of a source program is used as a pseudo variable in the constraint equation. Since the name of the argument in the function declaration does not match the formal parameter of function, the pseudo prototype part parameter is used so as to associate the argument name of the function declaration part with the formal parameter of the function definition and associate the argument name of the function declaration part with the actual parameter of the function call.

Further, according to the pseudo prototype part parameter, a function definition part constraint is assumed to be a pseudo prototype part parameter constraint equation. In the case where the function definition corresponding to the function declaration exists in the source program, a function definition part constraint that is obtained by replacing a pseudo prototype part parameter of a pseudo prototype part parameter constraint equation with a formal parameter variable of the corresponding function is used to optimize a clone of the function by assuming the function definition part constraint results in true. Further, the function call statement is replaced with a call statement for the function to be cloned, in the case where the function call statement corresponding to the function declaration exists in the source program and where the function definition part constraint in which the pseudo prototype part parameter of the pseudo prototype part parameter constraint equation is replaced with an actual parameter variable of a corresponding function results invariably in true.

According to this structure, it is possible to optimize a function even when cloning the function and replacing the function call are carried out on different files, by using the constraint equation associated with the function declaration as an intermediary. This enables adaptation for a division compile.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The program conversion apparatus according to the present invention can be applied to a compiler and the like which generate a program suitable to a target machine based on a source program described in a high-level language.

What is claimed is:

1. A program conversion method for converting a source program using a computer, said method comprising:
obtaining a constraint equation including at least one of: a variable in the source program; a constant; an operator; a pseudo variable; and a built-in function, the constraint equation resulting in a truth-value; and
converting the source program by optimizing the source program using the obtained constraint equation.

2. The program conversion method according to claim 1,
wherein in said converting, a function or statements contained in the source program associated with the constraint equation is optimized based on a condition under which the constraint equation results in a true value.

3. The program conversion method according to claim 1,
wherein a pseudo caller part parameter that is a variable for specifying a formal parameter of called function is used as the pseudo variable of the constraint equation.

4. The program conversion method according to claim 3,
wherein in said obtaining, the constraint equation including the pseudo caller part parameters, the constant, and the operator, is obtained and the constraint equation is associated with a function call statement, and
said converting includes:
generating a clone of the function that is called by the function call statement when the constraint expression which is given by replacing pseudo caller part parameters by the related actual parameter at the call statement results in a true value;
optimizing a process within the cloned function by assuming that the constraint equation results invariably in true; and
replacing the function that is called by the function call statement with the cloned function.

5. The program conversion method according to claim 1,
wherein a pseudo prototype part parameter that is a variable for specifying a formal parameter of function definition at the function declaration is used as the pseudo variable of constraint equation.

6. The program conversion method according to claim 5,
wherein in said obtaining, a constraint equation that is a constraint equation associated with a function declaration is obtained, the constraint equation including the pseudo prototype part parameter, the constant, and the operator, and
said converting includes:
optimizing, in the case where the function definition corresponding to the function declaration exists in the source program, a clone of the function by assuming a constraint equation which is given by replacing pseudo prototype part parameters by formal parameters in the function is true; and
replacing the function call statement with a call statement for the function to be cloned, in the case where the constraint equation which is given by replacing pseudo prototype part parameters by actual parameters in the function call results in true.

7. The program conversion method according to claim 1,
wherein the built-in function in the constraint equation is a constant judgment built-in function that returns true when an argument is a constant and returns false when an argument is not a constant.

8. The program conversion method according to claim 1,
wherein in said obtaining, a constraint equation that is associated with a function definition is obtained, the constraint equation including a formal parameter, the constant, and the operator, and
said converting includes:
generating a clone of the function indicated by the associated function definition;
optimizing a process within the cloned function by assuming that the constraint equation results in true; and
replacing function call statements which call when the constraint equation given by replacing formal parameters by actual parameters results in true.

9. The program conversion method according to claim 1,
wherein in said obtaining, an inner-function constraint equation is obtained, the inner-function constraint equation including at least a variable in a function, a global variable, a constant, and an operator, and
said converting includes:
obtaining, as optimization target statements, a statement sequence where all variables in constraint equation are live;
generating a conditional branching statement including: statements that are obtained by optimizing the optimization target statements assuming the inner-function constraint equation results in true, as a process in the case where a result of a conditional expression is true; and the original optimization target statements in the case where a result of the conditional expression is false, the conditional expression being the inner-function constraint equation; and
replacing the optimization target statements by the generated conditional branch statement that has been generated.

10. The program conversion method according to claim 1,
wherein in said obtaining, an inner-function constraint equation is obtained, the inner-function constraint equation including at least one of a variable in a function, a global variable, the constant, and the operator, and
said converting includes:
obtaining, from the function, two or more branch conditions, two or more branch destinations and a branch statement that includes an exclusive operation for each of the branch destinations or a branch-statement sequence; and
rearranging an order of evaluating a conditional expression of the branch statement or the branch-statement sequence in the case where an equation same as the inner-function constraint equation is included in any one of the two or more branch conditions.

11. The program conversion method according to claim 1,
wherein in said converting, the converted source program is further converted into an object program.

12. A program conversion apparatus which converts a source program, said program conversion apparatus comprising:
an obtainment unit configured to obtain a constraint equation including at least one of: a variable in the source program; a constant; an operator; a pseudo variable; and a built-in function, the constraint equation resulting in a truth-value; and
a conversion unit configured to convert the source program by optimizing the source program using the obtained constraint equation.

13. A computer readable recording medium on which a program is stored, said program, when executed by a computer, performs the steps of:
obtaining a constraint equation including at least one of: a variable in the source program; a constant; an operator; a pseudo variable; and a built-in function, the constraint equation resulting in a truth-value; and
converting the source program by optimizing the source program using the obtained constraint equation.
